(19) United States
(12) Patent Application Publication
(10) Pub. No.: US 2026/0136257 A1
(43) Pub. Date: May 14, 2026

(54) CONVERGED SEAMLESS MOBILITY DOMAIN (SMD) ARCHITECTURE ENABLING DIFFERENT SMD MODES

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US); Stephen M. Orr, Wallkill, NY (US); Sudhir Kumar Jain, Fremont, CA (US)

(73) Assignee: Cisco Technology, Inc., San Jose, CA (US)

(21) Appl. No.: 19/281,383

(22) Filed: Jul. 25, 2025

Related U.S. Application Data
(60) Provisional application No. 63/718,302, filed on Nov. 8, 2024.
(60) Provisional application No. 63/744,051, filed on Jan. 10, 2025.
(60) Provisional application No. 63/776,644, filed on Mar. 24, 2025.

(51) Int. Cl. H04W 36/18; H04W 12/0431; H04W 12/06

(52) U.S. Cl. CPC H04W 36/18; H04W 12/0431; H04W 12/06

(57) ABSTRACT

A converged Seamless Mobility Domain (SMD) architecture enabling different SMD modes may be provided. A request to roam may be received from a non-Access Point (AP) Multi-Link Device (MLD) to roam from a first AP MLD to a second AP MLD of the converged SMD architecture. The converged SMD architecture can selectively be configured in one of: a distributed SMD mode and a centralized SMD mode. It may be determined that the converged SMD architecture is configured in the distributed SMD mode. An uplink data path to a distribution system for the non-AP MLD through the first AP MLD may be paused during a roaming transition. The non-AP MLD may be connected to the distribution system through first AP MLD. During the roaming transition, the uplink data path to the distribution system for the non-AP MLD may be changed from through the first AP MLD to through the second AP MLD.

### RELATED APPLICATION

Under provisions of 35 U.S.C. §119(e), Applicant claims the benefit of U.S. Provisional Application No. 63/718,302, filed Nov. 8, 2024, U.S. Provisional Application No. 63/744,051, filed Jan. 10, 2025, and U.S. Provisional Application No. 63/776,644, filed Mar. 24, 2025, which are incorporated herein by reference.

### TECHNICAL FIELD

The present disclosure relates generally to a converged Seamless Mobility Domian (SMD) architecture enabling different SMD modes.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for providing a converged Seamless Mobility Domain (SMD) architecture enabling different SMD modes;

FIG. 2 illustrates a first example converged SMD architecture where a SMD-Management Entity (ME) is hosted on a controller;

FIG. 3 illustrates a second example converged SMD architecture where a SMD-ME is hosted on multiple member Access Point (AP) Multi-Link Devices (MLDs);

FIG. 4 illustrates a third example converged SMD architecture where a SMD-ME exposes different MAC-SAPs to a Distribution System (DS) for each member AP MLD;

FIG. 5 illustrates a fourth example converged SMD architecture where a SMD-ME is hosted at each member AP MLDS with separate MAC-SAPs to a DS for each member AP MLD;

FIG. 6 illustrates a fifth example converged SMD architecture where a SMD-ME is hosted at a centralized entity that exposes a single MAC-SAP for member AP MLDs;

FIG. 7 is a flow chart of a first method for roaming in a converged SMD architecture when the converged SMD architecture is configured in a distributed SMD mode;

FIG. 8A-8C illustrate roaming transitions of a non-AP MLD in a converged SMD architecture when the converged SMD architecture is configured in a distributed SMD mode;

FIG. 9 is a flow chart of a second method for roaming in a converged SMD architecture when the converged SMD architecture is configured in a centralized SMD mode;

FIG. 10A-10C illustrate roaming transitions of a non-AP MLD in a converged SMD architecture when the converged SMD architecture is configured in the centralized SMD mode;

FIG. 11 is a flow chart of a method for associating with a converged SMD architecture; and

FIG. 12 is a block diagram of a computing device.

### DETAILED DESCRIPTION

### Overview

A converged Seamless Mobility Domain (SMD) architecture enabling different SMD modes may be provided. A request to roam may be received from a non-Access Point (AP) Multi-Link Device (MLD) to roam from a first AP MLD to a second AP MLD of the converged SMD architecture. The converged SMD architecture can selectively be configured in one of: a distributed SMD mode and a centralized SMD mode. It may be determined that the converged SMD architecture is configured in the distributed SMD mode. An uplink data path to a distribution system for the non-AP MLD through the first AP MLD may be paused during a roaming transition. During the roaming transition, the uplink data path to the distribution system for the non-AP MLD may be changed from through the first AP MLD to through the second AP MLD.

Both the foregoing overview and the following example implementations are examples and explanatory only and should not be considered to restrict the disclosure's scope, as described and claimed. Furthermore, features and/or variations may be provided in addition to those described. For example, implementations of the disclosure may be directed to various feature combinations and sub-combinations described in the example implementations.

### Example Implementations

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Seamless roaming capability has been an area of interest for improving roaming quality within wireless networks. For instance, the next generation of the Institute of Electrical and Electronics Engineers (IEEE) 802.11 (that is, Wi-Fi 8) may seek roaming enhancements to support more reliable and seamless roaming. To achieve seamless roaming, a roaming transition time and delays added due to roaming related operations may need to be reduced. In one example, to support seamless roaming, a Station (STA) may create an association with a Seamless Mobility Domain (SMD) instead of with an individual Access Point (AP) Multi-Link Device (MLD). Associating with a SMD may enable the STA to roam seamlessly between member AP MLDs of the SMD without requiring reassociation and reestablishment of contexts with each new AP MLD. That is, associating with a SMD may ensure that when the STA moves from the current AP to a target AP MLD, the STA may not need to perform reassociation and rekeying, and the STA context may be transferred from the current AP MLD to the target AP MLD to achieve seamless roaming. Thus, by enabling the STA to associate with a SMD that includes multiple member AP MLD s may significantly reduce roaming time to realize seamless roaming (e.g., smooth and continuous roaming with no apparent interruption in data communication) and significantly improve a STA's wireless performance in terms of increased throughput, reduced latency, and higher range, as illustrative, non-limiting examples.

There may be two different modes of SMD. In a first mode, also referred to as a distributed SMD mode, a different Media Access Control (MAC)-Service Access Point (SAP) to a Distribution System (DS) may be provided for each member AP MLD. The distributed SMD mode may include multiple non-co-located AP MLDs, where each AP MLD may expose its own MAC SAP to the DS. In a second mode, also referred to as a centralized SMD mode, a single MAP-SAP may be provided for all member AP MLDs. Thus, the centralized SMD mode may include multiple non-co-located AP MLDS, where a single MAC-SAP may be exposed to the DS across all member AP MLDs. The disclosure may provide a converged SMD architecture that may support both variants of the SMD modes.

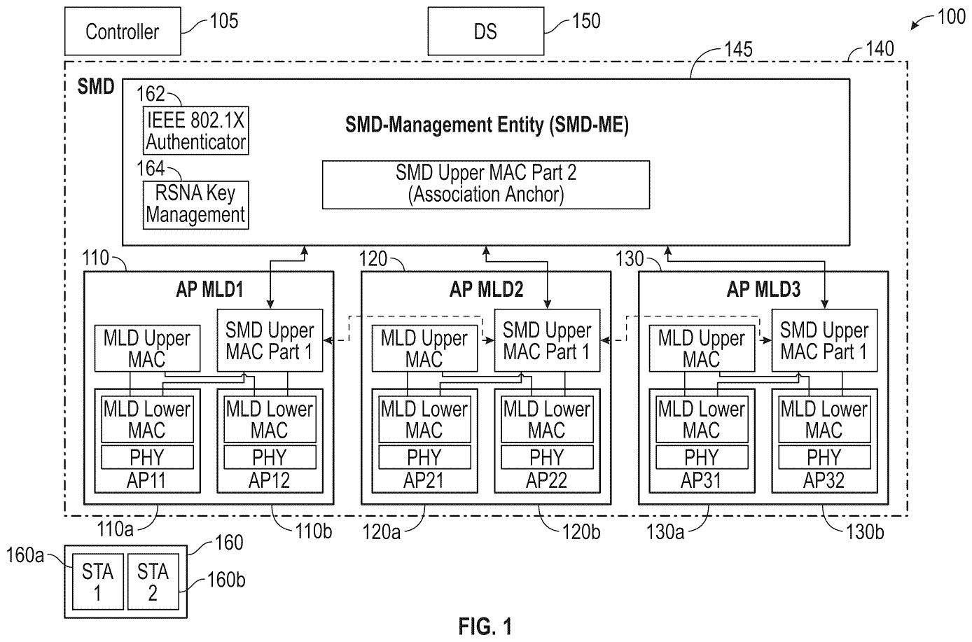

FIG. 1 is a block diagram of an operating environment 100 for providing a converged SMD architecture enabling different SMD modes. As shown in FIG. 1, operating environment 100 may comprise a controller 105 and a plurality of AP Multi-Link Devices (MLDs), for example, a first AP MLD 110, a second AP MLD 120, and a third AP MLD 130. Each of the plurality of AP MLDs may include one or more APs. For example, first AP MLD 110 may include a first AP 110a and a second AP 110b, second AP MLD 120 may include a third AP 120a and a fourth AP 120b, and third AP MLD 130 may include a fifth AP 130a and a sixth AP 130b.

Operating environment 100 may further include a converged SMD architecture 140 that includes a Management Entity (SMD-ME) 145. Operating environment 100 may further include a DS 150 and a non-AP MLD 160. Converged SMD architecture 140 may define a set of member AP MLDs (that is, first AP MLD 110, second AP MLD 120, and third AP MLD 130), across which non-AP MLD 160 may perform seamless roaming. SMD-ME 145 may be a logical entity that may provide a single anchor point for management functions. For example, SMD-ME 145 may include an IEEE 802.1X authenticator 162 and a Robust Security Network Association (RSNA) key management 164.

SMD-ME 145 may be identified with or may include a unique identifier (for example, 48-bit Media Access Control (MAC) address). The SMD-ME unique identifier may also be an 802.1X authenticator address of SMD-ME 145. Pairwise Master Key Security Association (PTKSA) and Pairwise Transient Key Security Association (PTKSA) may be provided by SMD-ME based on the 802.1X authenticator address and non-AP MLD's 160 MAC address.

SMD-ME 145 may host a SMD upper Upper-MAC (U-MAC) (also referred to as SMD Upper MAC part 2) of the member AP MLDs and may interface with a SMD lower U-MAC (also referred to as SMD Upper Mac part 1) hosted on member AP MLDs. This interface may be defined by the Wireless Fidelity (WiFi) Alliance (WFA) or be internal to an implementation. In some examples, upper MAC functions at SMD-ME 145 may include at a minimum authentication, association, and security association management. Split of other upper MAC functions between SMD-ME 145 and member AP MLDs may be based on distributed vs centralized SMD modes. Member AP MLDs of converged SMD architecture 140 may interface with each other for context transfer in the distributed SMD mode.

Non-AP MLD 160 may include a first STA 160a and a second STA 160b. DS 150 may include wired ethernet or a mesh network used to connect multiple AP MLDs of converged SMD architecture 140. Converged SMD architecture 140 may provide a coverage environment, for example, but is not limited to, a Wireless Local Area Network (WLAN) comprising the plurality of AP MLDs that may provide wireless network access (e.g., access to the WLAN for non-AP MLD 160 as it moves within converged SMD architecture 140). Non-AP MLD 160 may comprise, but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device. Each of the plurality of APs may be compatible with specification standards such as, but not limited to, the IEEE 802.11 specification standard for example.

The plurality of AP MLDs and non-AP MLD 160 of operating environment 100 may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network (LAN) Controller (WLC) and may provision and control the coverage environment (for example, a WLAN). In some implementations of the disclosure, controller 105 may be implemented by a Digital Network Architecture Center (DNAC) controller (i.e., a Software-Defined Network (SDN) controller.

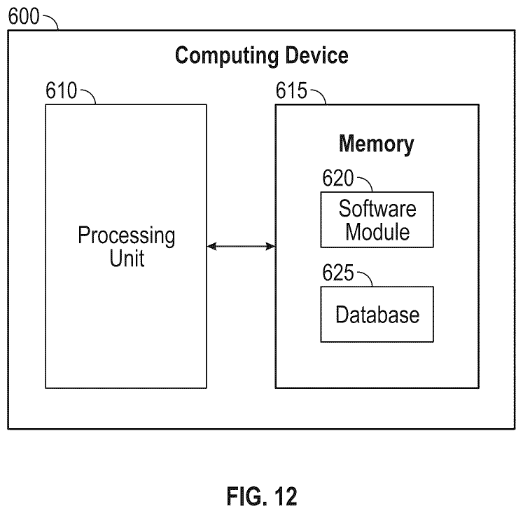

The elements described above of operating environment 100 (e.g., controller 105, first AP MLD 110, second AP MLD 120, third AP MLD 130, converged SMD architecture 140, SMD-ME 145, DS 150, or non-AP MLD 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 12, the elements of operating environment 100 may be practiced in a computing device 600.

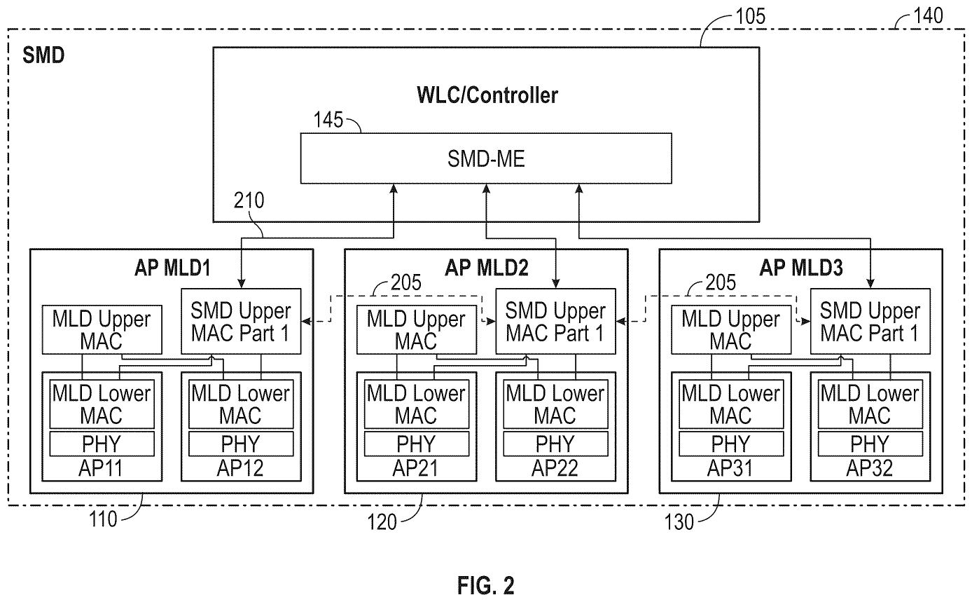

In examples, SMD-ME 145 may be hosted on a central controller or an individual AP MLD of converges roaming architecture 140. FIG. 2 illustrates a first example converged SMD architecture 140 where SMD-ME 145 is hosted on controller 105. Thus, in the first example converged SMD architecture 140 of FIG. 2, controller 105 may provide 802.1X authenticator 162 and association functions for non-AP MLD 160. Context related to non-AP MLD 160 may be transferred between AP MLDs when SMD-ME 145 may be exposing a single MAC-SAP for member AP MLDs (indicated as 205). SMD-ME 145 may interface with the MLD U-MAC part 1 hosted on member AP MLDs (indicated as 210).

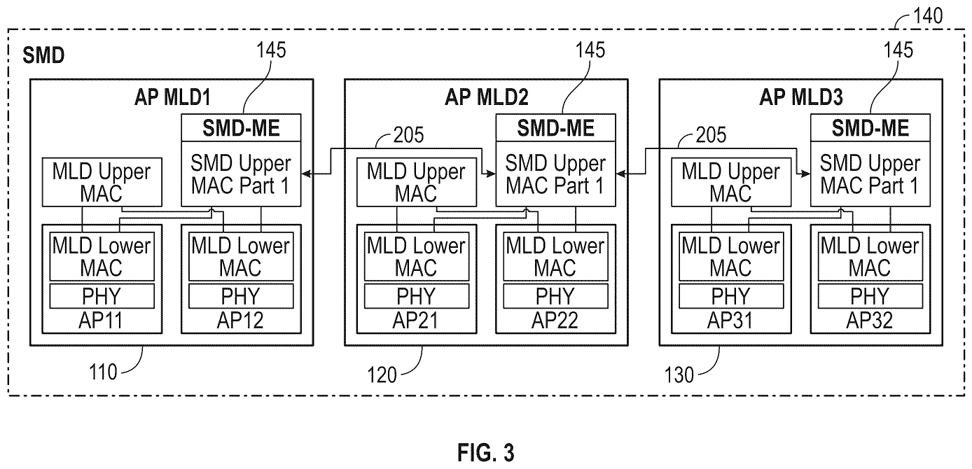

In some examples, SMD-ME 145 may be hosted on multiple AP MLDs of converged SMD architecture 140. FIG. 3 illustrates a second example converged SMD architecture 140 where SMD-ME 145 is hosted on multiple member AP MLDs. For example, as shown in FIG. 3, SMD-ME 145 is hosted on each of first AP MLD 110, second AP MLD 120, and third AP MLD 130. Thus, in second example converged SMD architecture 140 of FIG. 3, IEEE 802.1X authenticator 162 and association functions for non-AP MLD 160 may be hosted in a distributed manner on member AP MLDs of converged SMD architecture 140. Context related to non-AP MLD 160 may be transferred between AP MLDs during seamless roaming (indicated as 205).

IEEE 802.1X authenticator 162 of SMD-ME 145 may provide authentication functions for non-AP MLD 160 when authenticating with SMD-ME 145. For example, when non-AP MLD 160 authenticates and associates with SMD-ME 145, a pair of IEEE 802.1X ports (for example, Uncontrolled (U) and Controlled (C) ports) may be created by IEEE 802.1X authenticator 162 for non-AP MLD 160. Authentication may be done through the IEEE 802.1X U and IEEE 802.1X C ports. In addition, a data path to DS 150 may be managed and controlled through the IEEE 802.1X U-port and the IEEE 802.1X C port.

SMD-ME 145 may expose different MAC-SAPs (for each AP MLD of SMD architecture 140) or a single MAC-SAP (across all AP MLDs of SMD architecture 140) to DS 150 for MAC Service Data Unites (MSDUs) exchange. SMD-ME 145 may advertise the deployed mode (different MAC-SAPs vs a single MAC-SAP). Non-AP MLD 160 behavior may depend on the deployed SMD mode. For example, in case of different MAC-SAPs, non-AP MLD 160 may initiate context transfer or renegotiation, but context transfer may not be needed in case of a single MAC-SAP.

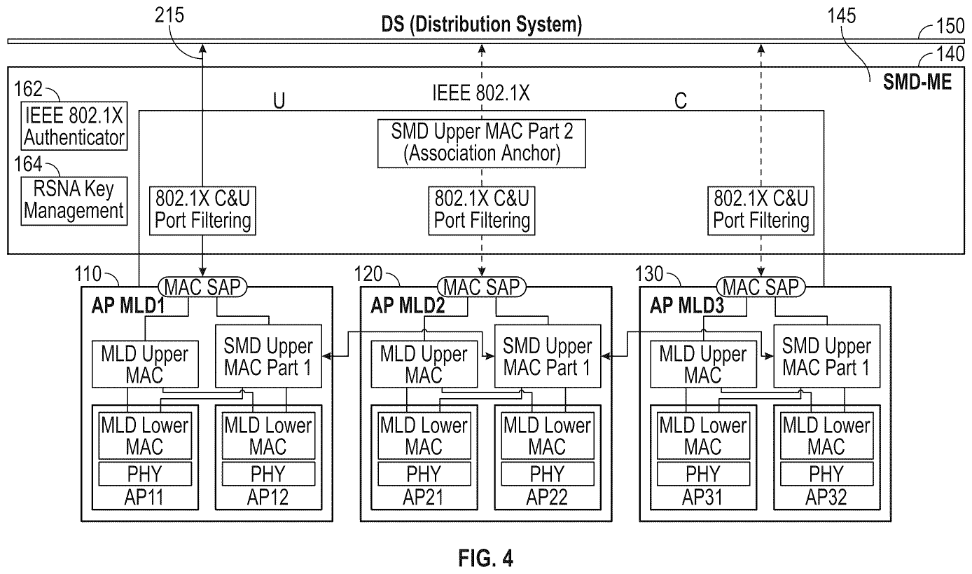

FIG. 4 illustrates a third example converged SMD architecture 140 where SMD-ME 145 may expose different MAC-SAPs to DS 150 for each member AP MLD. Converged SMD architecture 140 where SMD-ME 145 may expose different MAC-SAPs to DS 150 for each member AP MLD may also be referred to as a distributed SMD mode. As shown in FIG. 4, access to DS 150 via the IEEE 802.1X C-port may be enabled only through a MAC-SAP of one of the member AP MLDs at a time (for example, first MLD 110) (indicated by solid arrow 215 between first AP MLD 110 and DS 150). At initial SMD association with first AP MLD 110, the IEEE 802.1X C-port for first AP MLD 110 may be unblocked (for example, through IEEE 802.1X C and U port filtering at first AP MLD). During seamless roaming execution to second AP MLD 120, for example, IEEE 802.1X authenticator 162 may block the IEEE 802.1X C-port at first AP MLD 110 to DS 150 (for uplink traffic) and the IEEE 802.1X C-port at second AP MLD 120 may be unblocked for both the uplink and downlink data traffic until DS mapping change is initiated by second AP MLD 120. After the DS mapping change, the data transfer with DS 150 may be opened through the IEEE 802.1X C-port of second AP MLD 120 for both the uplink and the downlink data traffic.

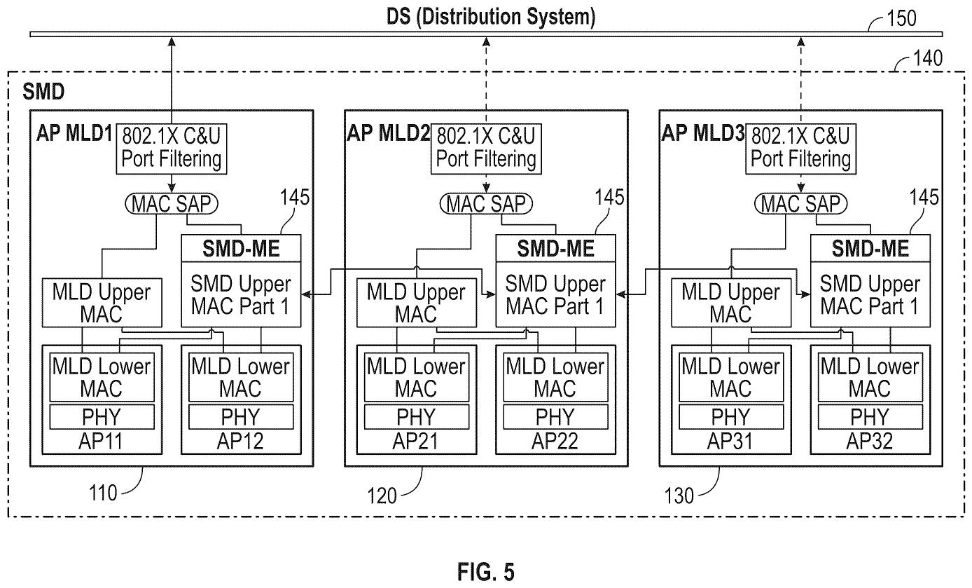

FIG. 5 illustrates a fourth example converged SMD architecture 140 where SMD-ME 145 may be hosted at each member AP MLDS with separate MAC-SAPs to DS 150 for each member AP MLD. As shown in FIG. 5, In fourth example converged SMD architecture 140, each member AP MLD may a host IEEE 802.1X authenticator component (that is, IEEE 802.1X C & U port filtering) as part of SMD-ME 145. IEEE 802.1X authenticator 162 may manage the 802.1X C-port at respective member AP MLD. During seamless roaming to second AP MLD 120, after receiving a roaming request, the 802.1X C-port (for the uplink) may be blocked at first AP MLD 110. The downlink data from DS 150 may continue to flow to first AP MLD 110 during the seamless roaming transition, even if the 802.1X C-port may be blocked for the uplink data. As part of the roaming transition procedure, the 802.1X C-port at the target AP MLD (that is, second MLD 120) may be unblocked. The unblocking of the 802.1X C-port at second AP MLD 120 may be done after a DS mapping change is initiated by second AP MLD 120.

IEEE 802.1X authenticator 162 of SMD-ME 145 at first AP MLD 110 (that is, the current AP MLD) and second AP MLD 120 (that is, the target AP MLD) may be identified by a same address, for example, the SMD MAC address. The MAC-SAP of each member AP MLD may be identified by the AP MLD MAC address. In an example implementation, during the seamless roaming procedure after the roaming preparation request/response exchange, the IEEE 802.1X C-port may be unblocked at the target AP MLD (that is, second AP MLD 120). The links setup with the target AP MLD (that is, second AP MLD 120) are in PS, and the DS mapping change may not be triggered by the target AP MLD (that is, second AP MLD 120). The target AP MLD (that is, second AP MLD 120) may not allow the uplink data from non-AP MLD 160 until the roaming execution is performed.

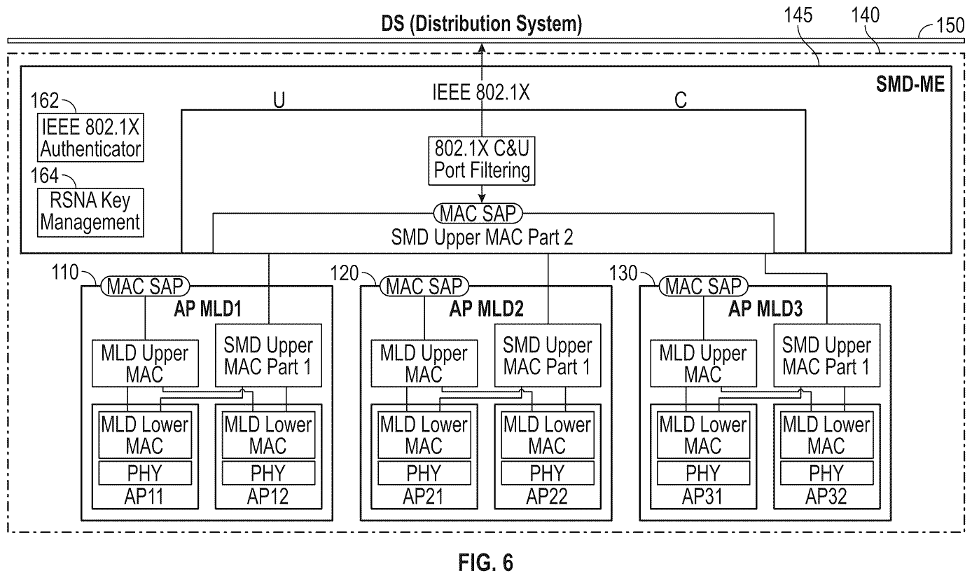

FIG. 6 illustrates a fifth example converged SMD architecture 140 where SMD-ME 145 may be hosted at a centralized entity that exposes a single MAC-SAP for member AP MLDs of converged SMD architecture 140. Converged SMD architecture 140 where SMD-ME 145 may expose a single MAC-SAP for member AP MLDs is also refereed to as a centralized SMD mode. The single MAC-SAP may be identified by an a unique SMD identifier for example, a SMD MAC address. IEEE 802.1X authenticator 162, also identified by the SMD MAC address, may manage the blocking and unblocking of IEEE 802.1X C-ports for non-AP MLD 160. During seamless roaming to second AP MLD 120, no DS mapping change may be initiated. However, the attachment point for non-AP MLD 160 may be changed from first AP MLD 110 to second AP MLD 120. Split of upper MAC data path functionality between a member AP MLD and SMD-ME 145 may be implementation dependent.

Thus, converged SMD architecture 140 may be enabled or configured in a distributed SMD mode or a centralized SMD mode. In some examples, converged SMD architecture 140 may be enabled or configured in a hierarchical SMD mode which may include another converged SMD architecture enabled in a centralized SMD mode that may be a member of the distributed SMD mode.

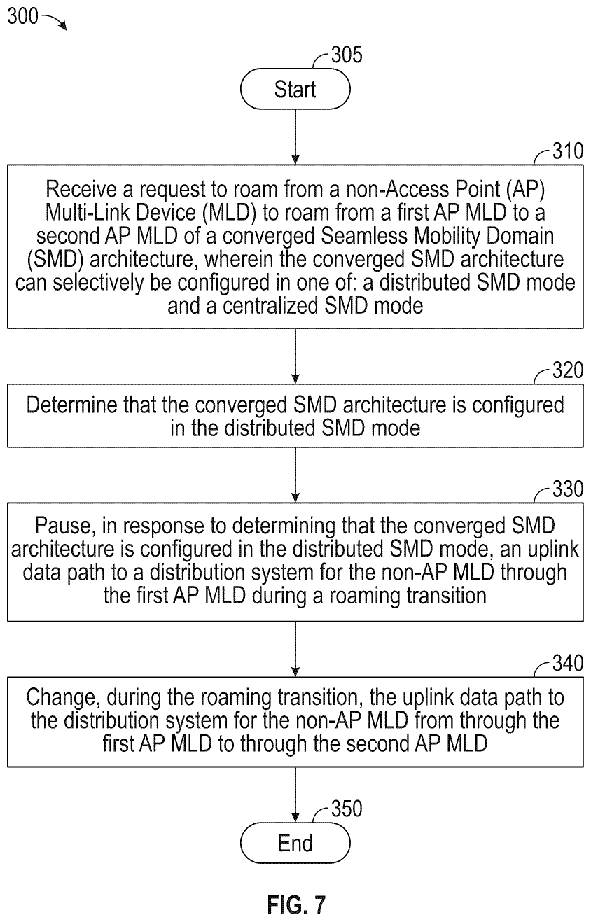

FIG. 7 is a flow chart setting forth the general stages involved in a first method 300 consistent with implementations of the disclosure for roaming in converged SMD architecture 140. Method 300 may be implemented using SMD-ME 145 as described in more detail above with respect to FIGS. 1-6. In some examples, first method 300 may be implemented using any of the plurality of AP MLDs of converged SMD architecture 140 as described in more detail above with respect to FIGS. 1-6. Ways to implement the stages of first method 300 will be described in greater detail below.

Method 300 may begin at starting block 305 and proceed to stage 310 where a request to roam from may be received from non-AP MLD 160 to roam from first AP MLD 110 to second AP MLD 120 of converged SMD architecture 140. As discussed above, converged SMD architecture 140 may selectively be configured in one of: a distributed SMD mode and a centralized SMD mode. Non-AP MLD 160 may be associated with converged SMD architecture 140 through first AP MLD 110.

After received the request to roam from non-AP MLD 160 at stage 310, method 300 may proceed to stage 320 wherein it may be determined that converged SMD architecture 140 may be configured in the distributed SMD mode.

Once having determined that converged SMD architecture 140 may be configured in the distributed SMD mode at stage 320, method 300 may proceed to stage 330 where in response to determining that converged SMD architecture 140 is configured in the distributed SMD mode, an uplink data path to DS 150 for non-AP MLD 160 through first AP MLD 110 may be paused during a roaming transition. In some examples, and as discussed above, IEEE 802.1x authenticator 162 may pause the uplink data path to DS 150 for non-AP MLD 160 through first AP MLD 110 by blocking IEEE 802.1x C-port.

After pausing the uplink data path to DS 150 for non-AP MLD 160 at stage 330, method 300 may proceed to stage 340 where during the roaming transition, the uplink data path to DS 150 for non-AP MLD 160 may be changed from through first AP MLD 110 to through second AP MLD 120. Once having changed the uplink data path for non-AP MLD 160 from through first AP MLD 110 to through second AP MLD 120 at stage 340, method 300 may terminate at end stage 350.

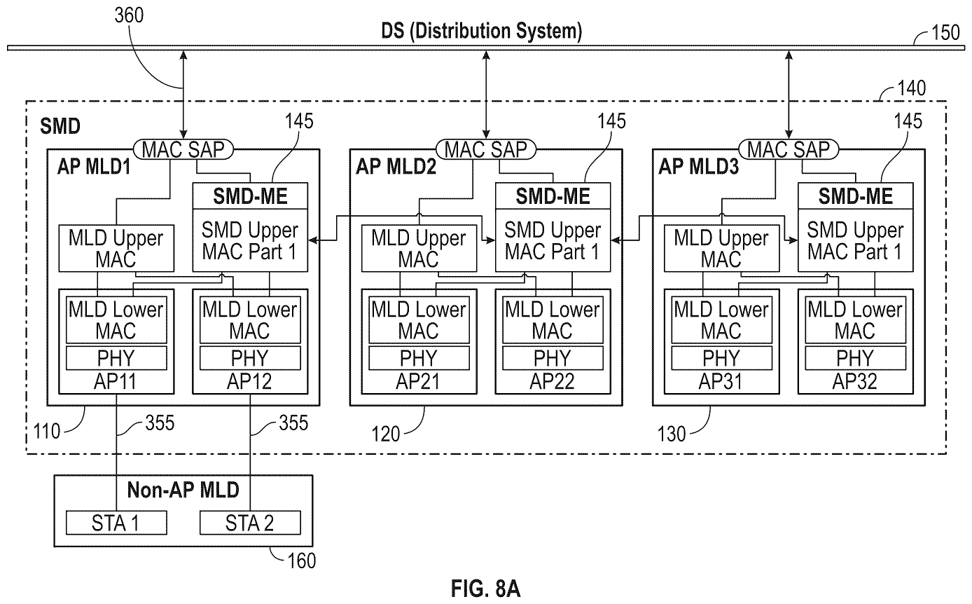

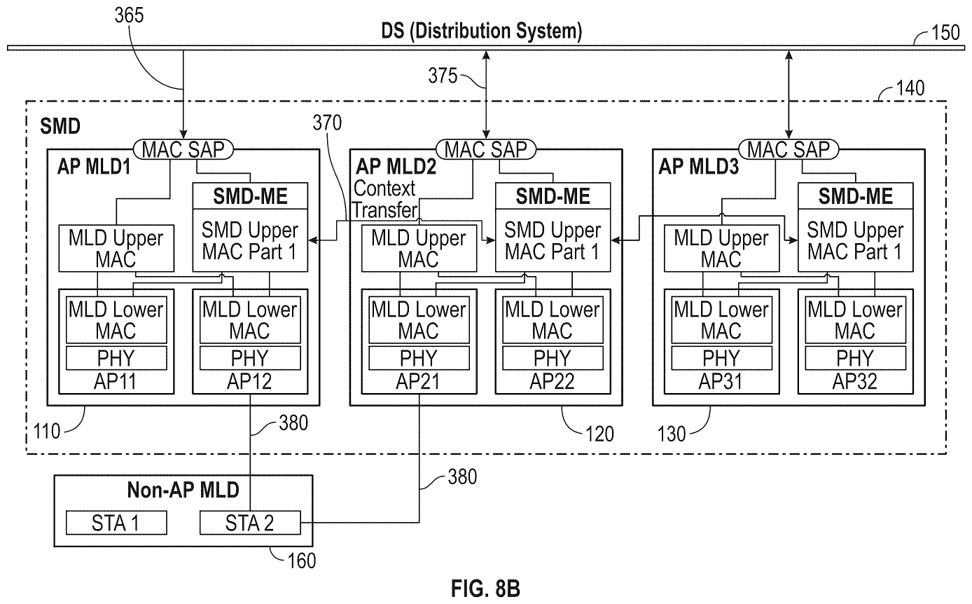

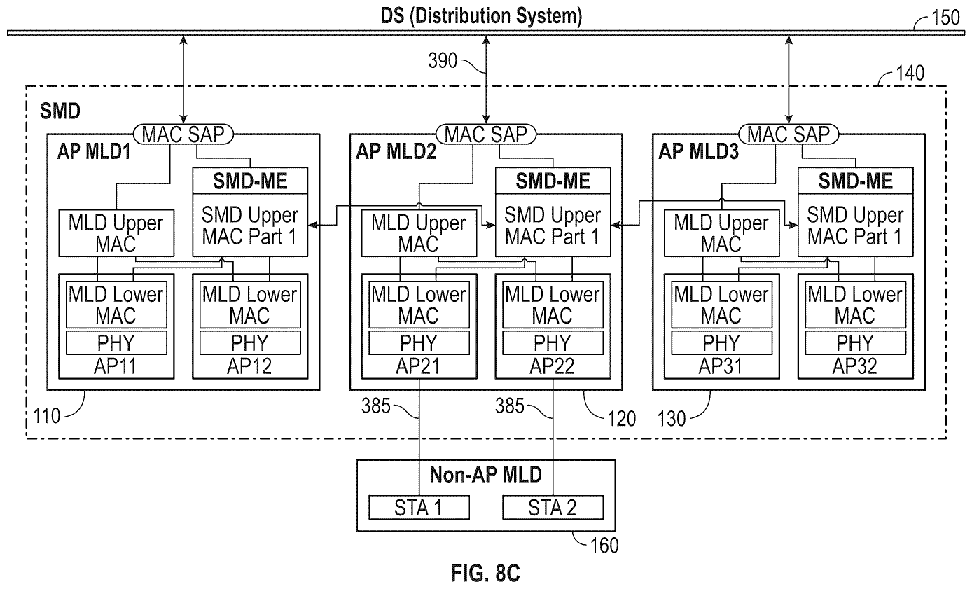

FIG. 8A-8C illustrate roaming transitions of non-AP MLD 160 in converged SMD architecture 140 when converged SMD architecture 140 is configured in the distributed SMD mode. FIG. 8A, for example, illustrates a roaming initiation phase. As shown in FIG. 8A, SMD-ME 145 is distributed on each of first AP MLD 110, second AP MLD 120, and third AP MLD 130. In addition, each of first AP MLD 110, second AP MLD 120, and third AP MLD 130 may have its own MAC-SAP. Non-AP MLS 160 may be connected to converged SMD architecture 140 through first AP MLD 110 through multiple links (indicated as 355). Non-AP MLD 160 may be connected to DS 150 through first AP MLD 110. That is, first AP MLD 110 may provide an uplink data path and a downlink data path (indicated as 360) to DS 150 for non-AP MLD 160.

Non-AP MLD 160 may send a request to roam to a target AP MLD (for example, second AP MLD 120) from first APP MLD 110. FIG. 8B illustrates a roaming transition phase. For example, and as shown in FIG. 8B, non-AP MLD 160 may be in a roaming transition to second AP MLD 120 from first AP MLD 110. During the roaming transition, an uplink data path to DS 150 through first AP MLD 110 may be paused (indicated as 365). However, a downlink data path may not be paused, and non-AP MLD 160 may continue to receive downlink data through first AP MLD 110. A context transfer may be performed between first AP 110 and second AP 120 (indicated as 370). In addition, second AP 120 may initiate a DS mapping change for non-AP MLD 160. Following the initiation of the DS mapping change, both a downlink and a uplink data path may be enabled through second AP MLD 120 (indicated as 375). Thus, during the roaming transition, non-AP MLD may receive data through both first AP MLD 110 and second AP MLD 120, while being able to send data through second AP MLD 120 upon establishing of the uplink data path through second AP MLD 120. In addition, during the roaming transition, uplink data transmission from non-AP MLD 160 may be allowed to first AP MLD 110 and first AP MLD 110 may forward the uplink data to second AP MLD 120.

FIG. 8C illustrates a roaming completion phase. As shown in FIG. 8C, non-AP MLD 160 may have completed the roaming transition and may be now connected to second AP MLD 120 through multiple links (indicated as 385) to second AP MLD 120. In addition, non-AP MLD 160 may be connected to DS 150 through a data path provided by second AP MLD 120 (indicated as 390). Upon completion of the roaming transition, the downlink data path through first AP MLD 110 may be removed.

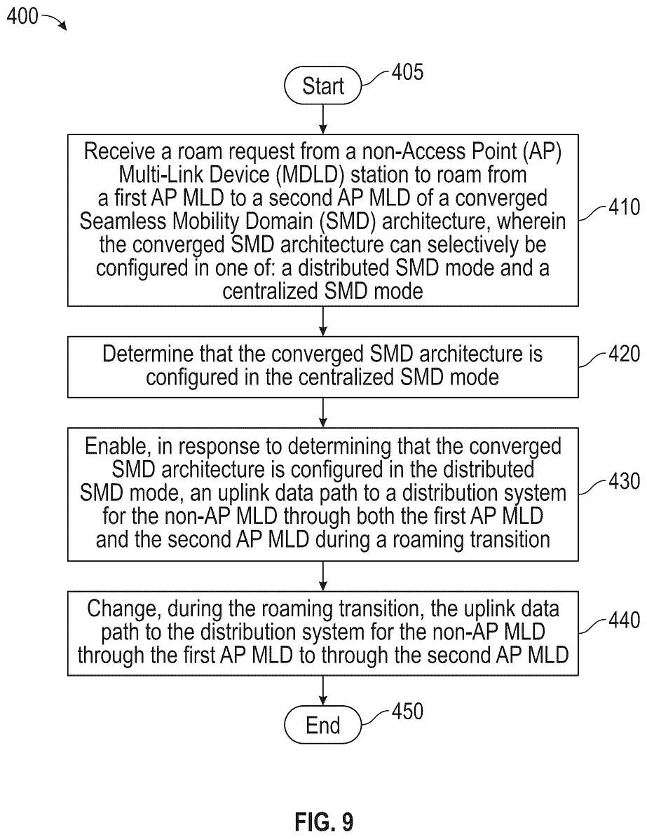

FIG. 9 is a flow chart setting forth the general stages involved in a second method 400 consistent with implementations of the disclosure for roaming in converged SMD architecture 140. Second method 400 may be implemented using SMD-ME 145 as described in more detail above with respect to FIGS. 1-6. In some examples, second method 400 may be implemented using any of the plurality of AP MLDs of converged SMD architecture 140 as described in more detail above with respect to FIGS. 1-6. Ways to implement the stages of second method 400 will be described in greater detail below.

Method 400 may begin at starting block 405 and proceed to stage 410 where a request to roam from may be received from non-AP MLD 160 to roam from first AP MLD 110 to second AP MLD 120 of converged SMD architecture 140. As discussed above, converged SMD architecture 140 may selectively be configured in one of: a distributed SMD mode and a centralized SMD mode.

After received the request to roam from non-AP MLD 160 at stage 410, method 400 may proceed to stage 420 wherein it may be determined that converged SMD architecture 140 may be configured in the centralized SMD mode.

Once having determined that converged SMD architecture 140 is configured in the centralized SMD mode at stage 420, method 400 may proceed to stage 430 where in response to determining that converged SMD architecture 140 is configured in the centralized SMD mode, an uplink data path to DS 150 for non-AP MLD 160 may be enabled through both first AP MLD 110 and second AP MLD 120 during a roaming transition.

After enabling the uplink data path to DS 150 for non-AP MLD 160 at stage 430, method 400 may proceed to stage 440 where during the roaming transition, the uplink data path to DS 150 for non-AP MLD 160 may be changed from through first AP MLD 110 to through second AP MLD 120. Once having changed the uplink data path for non-AP MLD 160 from through first AP MLD 110 to through second AP MLD 120 at stage 440, method 400 may terminate at end stage 450.

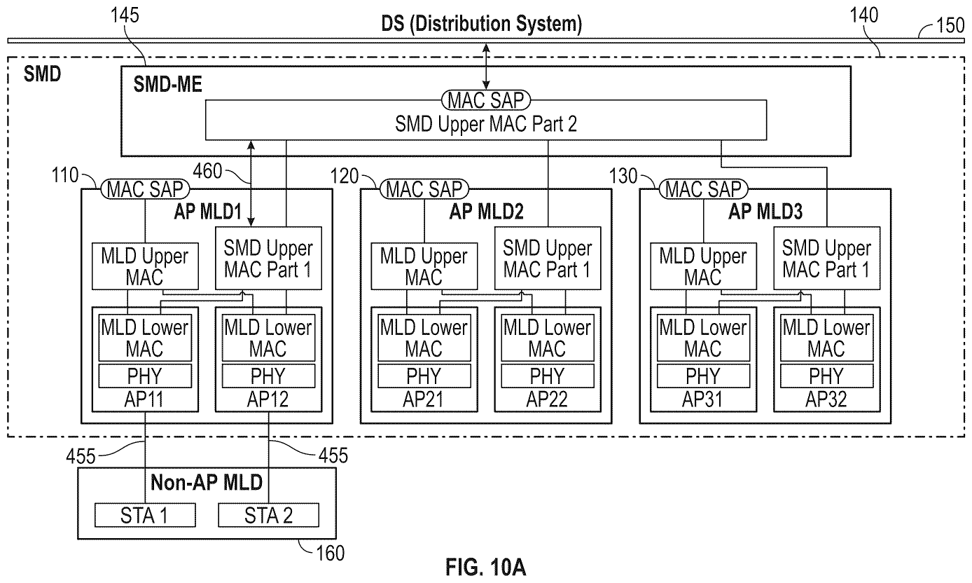

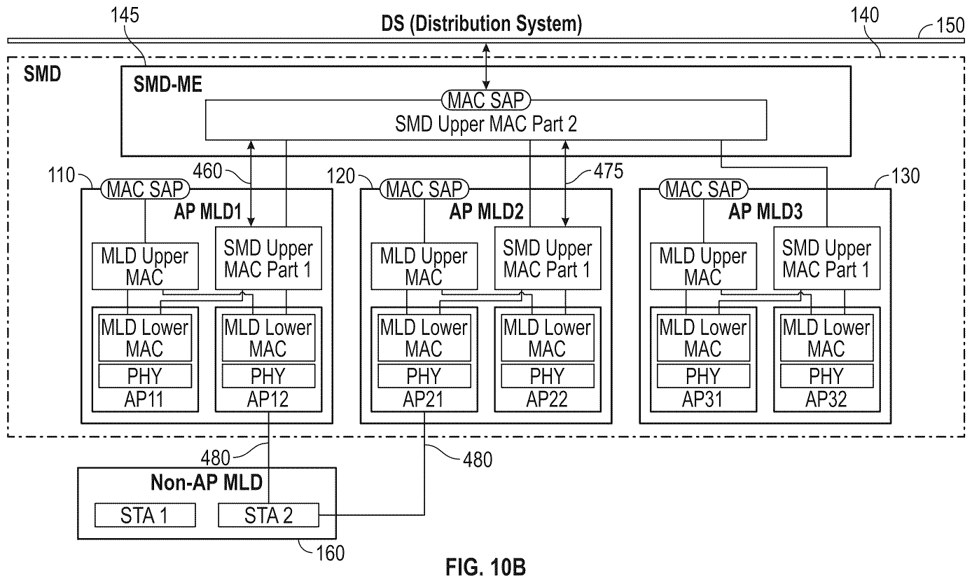

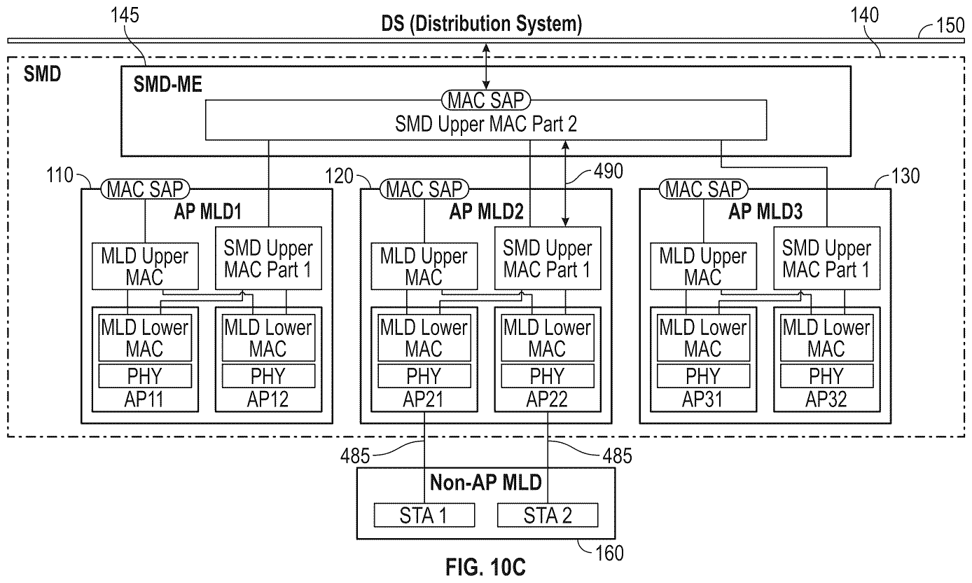

FIG. 10A-10C illustrate roaming transitions of non-AP MLD 160 in converged SMD architecture 140 when converged SMD architecture 140 is configured in the centralized SMD mode. FIG. 10A, for example, illustrates a roaming initiation phase. As shown in FIG. 10A, SMD-ME 145 is hosted on a centralized box with a single MAC-SAP for each of first AP MLD 110, second AP MLD 120, and third AP MLD. Non-AP MLS 160 may be connected to converged SMD architecture 140 through first AP MLD 110 through multiple links (indicated as 455). Non-AP MLD 160, therefore, may be connected to DS 150 through first AP MLD 110. That is, first AP MLD 110 may provide an uplink data path and downlink data path (indicated as 460) to DS 150 for non-AP MLD 160.

Non-AP MLD 160 may send a request to roam to a target AP MLD (for example, second AP MLD 120) from first APP MLD 110. FIG. 10B illustrates a roaming transition phase. For example, and as shown in FIG. 10B, non-AP MLD 160 may be in a roaming transition to second AP MLD 120 from first AP MLD 110. During the roaming transition, an uplink data path to DS 150 may be enabled through second AP MLD 120 (indicated as 475). A downlink data path may not be paused and non-AP MLD 160 may continue to receive downlink data through first AP MLD 110. A context transfer may not be needed between first AP 110 and second AP 120 in the centralized SMD mode. In addition, second AP 120 may initiate a DS mapping change for non-AP MLD 140. Following the initiation of the DS mapping change, both the downlink and uplink data path may be enabled through second AP MLD 120 (indicated as 475). Thus, during the roaming transition, the uplink data path and the downlink data path to DS 150 for non-AP MLD 160 is through both first AP MLD 110 and second AP MLD 12.

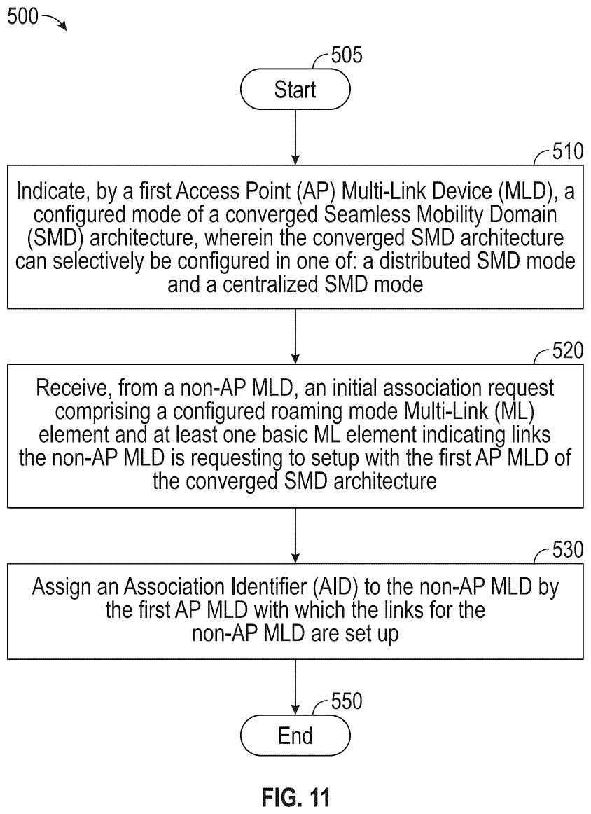

FIG. 11C illustrates a roaming completion phase. As shown in FIG. 11C, non-AP MLD 160 may have completed the roaming transition and may be now connected to second AP MLD 120 through multiple links (indicated as 485) to second AP MLD 120. In addition, non-AP MLD 160 may be connected to DS 150 through second AP MLD 120 (indicated as 490). Upon completion of the roaming transition, the downlink data path through first AP MLD 110 may be removed. Thus, after the roaming transition, the uplink data path and the downlink data path to DS 150 for non-AP MLD 160 may only be through second AP MLD 120. As discussed above, no DS mapping change is initiated during the roaming transition for non-AP MLD 160 in the centralized SMD mode.

FIG. 11 is a flow chart setting forth the general stages involved in a method 500 consistent with implementations of the disclosure for associating with converged SMD architecture 140. Method 500 may be implemented using SMD-ME 145 as described in more detail above with respect to FIGS. 1-6. In some examples, method 500 may be implemented using any of the plurality of AP MLDs of converged SMD architecture 140 as described in more detail above with respect to FIGS. 1-6. Ways to implement the stages of method 500 will be described in greater detail below.

Method 500 may begin at starting block 505 and proceed to stage 510 where a configured mode of converged SMD architecture 140 may be indicated. As discussed above, converged SMD architecture 140 may selectively be configured in one of: a centralized SMD mode and a distributed SMD mode. The configured roaming mode may be indicated in a beacon, a probe response, an association response, a re-association response, or another management frame.

In some examples, the configured mode may be provided in a common SMD element or a Seamless Basic Service Set (BSS) Transition Element (SBTE). The SBTE may include a roaming mode field/bitmap that may indicate either a distributed SMD mode or a centralized SMD mode. For a scenario when a hierarchical SMD mode may be deployed with in converged SMD architecture 140, the SBTE may indicate that both centralized SMD mode and the distributed SMD mode are supported; and which AP MLDs are part of the same centralized SMD (for example, via a centralized SMD ID). The SBTE may further include a SBT MAC address of SMD-ME 145. The SBTE may further include capabilities and policies as element/sub-element/field.

In some examples, a separate element may be included that may indicate configured mode of converged SMD architecture 140. In one embodiment, an Ultra High Reliability (UHR) operation element, or another element, may include a roaming mode field or a SBT mode field. This field may be set to indicate either the centralized SMD mode, the distributed SMD mode, or both for a hierarchical SMD mode. In some other examples, a Reduced Neighbor Report (RNR) may be extended to indicate the configured mode of converged SMD architecture 140. For example, a flag may be included in the RNR to indicate whether a neighbor AP MLD may be a part of converged SMD architecture 140 may may be configured in either the centralized SMD mode or the distributed SMD mode.

After indicating the configured mode of converged SMD architecture 140 at stage 510, method 500 may proceed to stage 520 where an initial association request may be received from non-AP MLD 160. The initial association request may comprise a configured roaming mode Multi-Link (ML) element and at least one basic ML element indicating links non-AP MLD 160 is requesting to setup with first AP MLD 110 of converged SMD architecture 140.

For example, non-AP MLD 160 may learn about the configured mode of converged SMD architecture 140 from a beacon, a probe response, etc. In its initial association request with converged SMD architecture 140, non-AP MLD 160 may include, if the distributed mode is configured, a distributed SMD element and one basic ML element indicating links of first AP MLD 110 non-AP MLD 160 may be requesting to setup. If the centralized SMD mode is configured, then the initial association request may include a centralized ML element and one or more basic ML element, one for each affiliated AP MLD of converged SMD architecture 140 with which link setup may be requested. Policy and capability indication advertised in a beacon or a probe response may limit setting up links with only a single AP MLD of converged SMD architecture 140. In the hierarchical mode, if non-AP MLD 160 is setting up links with a centralized SMD with a distributed SMD, then the initial association request may may include both the centralized ML element and the distributed ML element, and one or more basic ML elements.

Once having received the initial association request at stage 520, method 500 may proceed to stage 530 where an Association Identifier (AID) may be assigned to non-AP MLD 160 by first AP MLD 110 with which the links for non-AP MLD 160 may be set up. For the centralized SMD mode, if setting up links with multiple AP MLDs, then multiple AIDs with different values may be assigned to non-AP MLD 160. After assigning the AID to non-AP MLD 160 at stage 530, method 500 may terminate at end block 540.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing converged Seamless Mobility Domian (SMD) architecture enabling different SMD modes as described above with respect to FIGS. 7, 9 and 11. Computing device 600, for example, may provide an operating environment for controller 105, first AP MLD 110, second AP MLD 120, third AP MLD 130, converged SMD architecture 140, SMD-ME 145, DS 150, and non-AP MLD 160. Controller 105, first AP MLD 110, second AP MLD 120, third AP MLD 130, converged SMD architecture 140, SMD-ME 145, DS 150, and non-AP MLD 160 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 500 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
receiving a request to roam from a non-Access Point (AP) Multi-Link Device (MLD) to roam from a first AP MLD to a second AP MLD of a converged Seamless Mobility Domain (SMD) architecture, wherein the converged SMD architecture can selectively be configured in one of: a distributed SMD mode and a centralized SMD mode;
determining that the converged SMD architecture is configured in the distributed SMD mode;
pausing, in response to determining that the converged SMD architecture is configured in the distributed SMD mode, an uplink data path to a distribution system for the non-AP MLD through the first AP MLD during a roaming transition; and
changing, during the roaming transition, the uplink data path to the distribution system for the non-AP MLD from through the first AP MLD to through the second AP MLD.

2. The method of claim 1, further comprising:
updating, during the roaming transition, a downlink data path for the non-AP MLD from the first AP MLD to the second AP MLD; and
allowing, during the roaming transition, uplink data transmission from the non-AP MLD to the first AP MLD, and the first forwarding uplink data to the second AP MLD.

3. The method of claim 1, further comprising:
transferring context for the non-AP MLD from the first AP MLD to the second AP MLD.

4. The method of claim 1, wherein in the distributed SMD mode, a different Media Access Control (MAC)-Service Access Point (SAP) to the distribution system for each member AP MLD is provided for the uplink data path and a downlink data path.

5. The method of claim 1, wherein pausing the uplink data path to the distribution system from the first AP MLD during the roaming transition comprises:
blocking the uplink data path to the distribution system at a controlled port at the first AP MLD.

6. The method of claim 1, further comprising:
unblocking, during the roaming transition, a controlled port at the second AP MLD for the uplink data path and for a downlink data path from the distribution system for the non-AP MLD through the second AP MLD.

7. The method of claim 1, further comprising:
blocking, after the roaming transition, the uplink data path and a downlink data path to the distribution system at a controlled port at the first AP MLD.

8. The method of claim 1, wherein the converged SMD architecture comprises a SMD Management Entity (SMD-ME) that provides authentication and association functions for the non-AP MLD, and wherein the SMD-ME is hosted on a central controller or on one or more member AP MLDs of the converged SMD architecture.

9. The method of claim 8, wherein the SMD-ME comprises a unique identifier, and wherein the SMD-ME further comprises an Institute of Electrical and Electronics Engineers (IEEE) 802.1X authenticator.

10. The method of claim 8, wherein further comprising establishing, by the SMD-ME, Pairwise Master Key (PMK) Security Association (PMKSA) and Pairwise Transient Key (PTK) Security Association (PTKSA) for the non-AP MLD.

11. A system comprising:
a memory storage; and
a processing unit coupled to the memory storage, wherein the processing unit is operative to:
receive a roam request from a non-Access Point (AP) Multi-Link Device (MDLD) station to roam from a first AP MLD to a second AP MLD of a converged Seamless Mobility Domain (SMD) architecture, wherein the converged SMD architecture enables the converged SMD architecture to be selectively configured in one of: a distributed SMD mode and a centralized SMD mode;
determine that the converged SMD architecture is configured in the centralized SMD mode;
enabling, in response to determining that the converged SMD architecture is configured in the centralized SMD mode, an uplink data path to a distribution system for the non-AP MLD through both the first AP MLD and the second AP MLD during a roaming transition, wherein the non-AP MLD is connected to the distribution system through the first AP MLD; and
changing, during the roaming transition, the uplink data path to the distribution system for the non-AP MLD through the first AP MLD to through the second AP MLD.

12. The system of claim 11, wherein the converged SMD architecture comprises a SMD Management Entity (SMD-ME) that provides authentication and association functions for the non-AP MLD at the converged SMD architecture, and wherein the SMD-ME establishes Pairwise Master Key (PMK) Security Association (PMKSA) and Pairwise Transient Key (PTK) Security Association (PTKSA) for the non-AP MLD.

13. The system of claim 12, wherein the SMD-ME comprises a unique identifier, wherein the SMD-ME further comprises an Institute of Electrical and Electronics Engineers (IEEE) 802.1X authenticator.

14. The system of claim 13, wherein the IEEE 802.1X authenticator manages blocking and unblocking of controlled ports to the distribution system enabling and disabling the uplink data and the downlink data path for the non-AP MLD.

15. The system of claim 11, wherein:
during the roaming transition, the uplink data path and the downlink data path to the distribution system for the non-AP MLD is through both the first AP MLD and the second AP MLD;
after the roaming transition, the uplink data path and the downlink data path to the distribution system for the non-AP MLD is only through the second AP MLD; and
no distribution system mapping change is initiated during the roaming transition for the non-AP MLD.

16. The system of claim 11, wherein in the centralized SMD mode, a single Media Access Control (MAC)-Service Access Point (SAP) to the distribution system is provided for the converged SMD architecture across all member AP MLD of the converged SMD architecture.

17. A non-transitory computer-readable medium that stores a set of instructions which when executed perform a method executed by the set of instructions comprising:
indicating, by a first Access Point (AP) Multi-Link Device (MLD), a configured mode of a converged Seamless Mobility Domain (SMD) architecture, wherein the converged SMD architecture can be selectively configured in one of: a distributed SMD mode and a centralized SMD mode;
receiving, from a non-AP MLD, an initial association request comprising a configured mode Multi-Link (ML) element and at least one basic ML element indicating links the non-AP MLD is requesting to be setup with the AP MLD of the converged architecture; and
assigning an Association Identifier (AID) to the non-AP MLD by the AP MLD with which the links for the non-AP MLD are set up.

18. The non-transitory computer-readable medium of claim 17, wherein the converged SMD architecture comprises a SMD Management Entity (SMD-ME) that provides authentication and association functions for the non-AP MLD.

19. The non-transitory computer-readable medium of claim 18, wherein the SMD-ME comprises a unique identifier, and wherein the SMD-ME further comprises an Institute of Electrical and Electronics Engineers (IEEE) 802.1X authenticator.

20. The non-transitory computer readable medium of claim 19, wherein Pairwise Master Key (PMK) Security Association (PMKSA) and Pairwise Transient Key Security Association (PTKSA) keys are established between an 802.1X authenticator address and a non-AP MLD Media Access Control (MAC) address.
